(19) United States
(12) Patent Application Publication
(10) Pub. No.: US 2005/0269882 A1
(43) Pub. Date: Dec. 8, 2005

(54) Uninterruptible power supply

(76) Inventors: Nobuyuki Kobayashi, Tokyo (JP); Yasuhiro Okuma, Hyogo (JP); Hirokazu Tokuda, Tokyo (JP)

Correspondence Address: RABIN & BERDO, P.C.;Suite 500, 1101 14th Street, N.W., Washington, DC, 20005, US

(21) Appl. No.: 11/139,979

(22) Filed: May 31, 2005

(30) Foreign Application Priority Data
Jun. 8, 2004 (JP) JP 2004-169383

(51) Int. Cl. H02J 3/36

(52) U.S. Cl. 307/64

(57) ABSTRACT

An uninterruptible power supply includes a first converter connected in parallel with an AC power system, a second converter series-connected to the first converter, and an energy accumulation device connected between the first and second converters. A control apparatus controls the first converter and the second converter so that when the voltage of the AC power system is within a first voltage range, the second converter switches at a frequency of the AC power system and the system voltage is output via the second converter. When the system voltage is within a second voltage range, outside the first voltage range, the second converter is used to compensate the voltage of the AC power system to output a reference voltage value, and when the system voltage is outside the second voltage range, the energy accumulation means and the second converter are used to generate and output the reference voltage value.

### BACKGROUND OF THE INVENTION

1. Field of the Invention

The invention relates to a method of providing output voltage compensation, and more particularly to a method of providing output voltage compensation for an uninterruptible power supply by which steady power is provided from an AC power supply to a load, and energy accumulated in an energy accumulation means is used upon the occurrence of fluctuation in the AC power, to supply power to the load.

2. Prior Art

FIG. 3 illustrates an example of a conventional uninterruptible power supply described in Japanese Laid-Open Publication No. 2000-184622 (p. 5, FIG. 1 and FIG. 2). This is an uninterruptible power supply according to the series-parallel circuit method provided by a parallel converter having a parallel connection to an AC power supply and a series converter having a series connection to an AC power supply.

In FIG. 3, the AC side of a parallel-side converter 1 has a parallel connection via an open/close switch 9 to a AC power supply 5, while the AC side of the series-side converter 2 is series-connected between the AC power supply 5 and the load 6 via the open/close switch 9 and a switching switch 10. The DC sides of the parallel-side converter 1 and the series-side converter 2 are connected to the energy accumulation means 3. The control apparatus 4 controls the parallel-side converter 1, the series-side converter 2, the open/close switch 9, and the switching switch 10. The control apparatus 4 controls, based on the input voltage value Vin detected by the input voltage detector 7 and the DC voltage value Vd detected by the DC voltage detector 12, the energy accumulation means 3 to have a predetermined voltage. At the same time, the control apparatus 4 controls, based on the input voltage value Vin and the output voltage value Vout detected by the output voltage detector 8, a voltage applied to the load (i.e., the output voltage).

Next, details of the operation will be described. In the uninterruptible power supply of FIG. 3, the output voltage instruction switching section 13 provided in the control apparatus 4 is used to switch the output voltage target value Vout* depending on the input voltage value Vin, as shown in FIG. 4.

When the input voltage value Vin is equal to or higher than the lower limit value of the allowable value of the output voltage (hereinafter referred to as “VL1”) and is equal to or lower than the upper limit value of the allowable value of the output voltage (hereinafter referred to as “VU1”) (VL1≦Vin≦VU1), the open/close switch 9 is closed and the switching switch 10 for the bypass circuit 11 is turned on. Specifically, a commercial feeding operation for directly outputting an input voltage is performed. Then, the series-side converter 2 is stopped to reduce power loss within the apparatus. The parallel-side converter 1 operates as a rectifier based on the parallel-side output voltage instruction Vpara* from the control apparatus 4 so that the DC voltage value Vd of the energy accumulation means 3 is a predetermined voltage value.

When the input voltage value Vin is equal to or higher than the level at which the reduction of the input voltage is detected (hereinafter referred to as VL2) and is smaller than VL1 (VL2≦Vin≦VL1), the output voltage target value Vout* is VL1 and the series-side converter 2 makes up for any shortage in input voltage (VL1-Vin) by PWM control so that the output voltage is maintained at VL1. Then, based on the parallel-side output voltage instruction Vpara* from the control apparatus 4, the parallel-side converter 1 operates as a rectifier so that the DC voltage value Vd of the energy accumulation means 3 is a predetermined voltage value.

When the input voltage value Vin is higher than VU1 and equal to or lower than the level at which the increase in the input voltage is detected (hereinafter referred to as VU2) (VU1<Vin≦VU2), then the output voltage target value Vout* is VU1 and the series-side converter 2 outputs an excessive input voltage (VU1-Vin) by PWM control. The excessive input voltage maintains the output voltage at VU1. Based on the parallel-side output voltage instruction Vpara* from the control apparatus 4, the parallel-side converter 1 operates as a rectifier so that the DC voltage value Vd of the energy accumulation means 3 is maintained at a specified voltage.

When the input voltage value Vin is smaller than VL2 or larger than VU2 (Vin<VL2 or VU2<Vin), a voltage abnormality is determined to exist, and the uninterruptible power supply performs a backup operation. In the backup operation, the series-side converter 2 is stopped and the output voltage target value Vout* is Vr. Based on the output voltage target value Vout*, the parallel-side converter 1 operates as an inverter so that the output voltage is the specified voltage Vr and continues to supply power to the load by using the energy of the energy accumulation means 3.

### OBJECTS AND SUMMARY OF THE INVENTION

In the conventional example, when the input voltage Vin is VL2≦Vin<VL1, the series-side converter is PWM-controlled so that the output voltage Vout is VL1 and, when VU1<Vin≦VU2, the series-side converter is PWM-controlled so that the output voltage Vout is VU1. Thus, when the input voltage is rapidly changed to change the range of VL2≦Vin<VL1 to the range of VU1<Vin≦VU2 in an operation under an excessive load level, the output voltage target value Vout* is switched from VL1 to VU1, thus increasing the output power of the uninterruptible power supply. As a result, the semiconductor switch constituting the series-side converter has an increased duty within the range of VU1<Vin≦VU2, leading to the possibility of irreparable damage to the apparatus.

In the example of the conventional device, the output voltage target value is switched in the three input voltage ranges subjected to PWM control (VL2≦Vin<VL1, VU1<Vin≦VU2, Vin<VL2 or VU2<Vin). This causes a problem in that the control sequence is complex and the output power varies according to the input voltage, thus causing, even with the same load, a case in which an excessive load may or may not be detected. Furthermore, when the input voltage is within the range of VL2≦Vin<VL1 or VU1<Vin≦VU2, the allowable lower limit voltage or the allowable upper limit voltage is output, thus causing a problem in that a rapid change of the input voltage in this state causes a delay in the compensatory control operation, in turn causing the output voltage to exceed the allowable range for a certain period of time.

In view of the above, it is an objective of the invention to provide an uninterruptible power supply for solving these problems.

The reason that the semiconductor switch constituting the series-side converter has an increased duty when the input voltage is within the range of VU1<Vin≦VU2 and the reason that, even with the same load, an excessive load may or may not be detected, is that the output voltage target value Vout* varies according to the three input voltage ranges subjected to PWM control (VL2≦Vin<VL1, VU1<Vin≦VU2, Vin<VL2 or VU2<Vin).

The invention was arrived at by focusing on the fact that the output voltage target value Vout* is used as a single target value in the above three input voltage ranges, so that the output power is suppressed from varying according to input voltage in the above three input voltage ranges, and thus that an increase in the duty ratio of the semiconductor switch of the series-side converter can be minimized.

According to a first aspect of the invention, the output voltage target value Vout* is used as a single target value in the above three input voltage ranges so that the output power is suppressed from varying according to the input voltage, and so that the semiconductor switch of the series-side converter is suppressed from having an increased duty in the input voltage range of VU1<Vin≦VU2.

According to a second aspect of the invention, in the first invention, instead of performing a commercial feeding operation for directly outputting an input voltage when the input voltage is in the range of range of VL1≦Vin≦VU1, the semiconductor switch constituting the series-side converter is switched with a power supply frequency depending on the polarity of the power supply so that the input voltage is directly output via the semiconductor switch, thus reducing the loss.

According to the invention, a single output voltage target value is used in the above three input voltage ranges subjected to PWM control. Thus, in the above three input voltage ranges, the output voltage of the uninterruptible power supply can be maintained to have a predetermined value to minimize the effect of the input voltage on the output power, and to minimize an increase in duty ratio of the semiconductor switch of the series-side converter.

In the input voltage range of VL1≦Vin≦VU1, the input voltage is output via the semiconductor switch switched with the power supply frequency, and thus the apparatus can have a reduced loss without requiring a switch to a commercial feed.

### BRIEF DESCRIPTION OF THE DRAWINGS

FIG. 1 illustrates an operation pattern showing an embodiment of the invention.

FIG. 2 shows an example of a circuit of an uninterruptible power supply of the series parallel circuit method.

FIG. 3 shows an example of a conventional uninterruptible power supply.

FIG. 4 illustrates an operation pattern of a conventional uninterruptible power supply.

### DETAILED DESCRIPTION OF THE PREFERRED EMBODIMENTS

### Embodiment 1

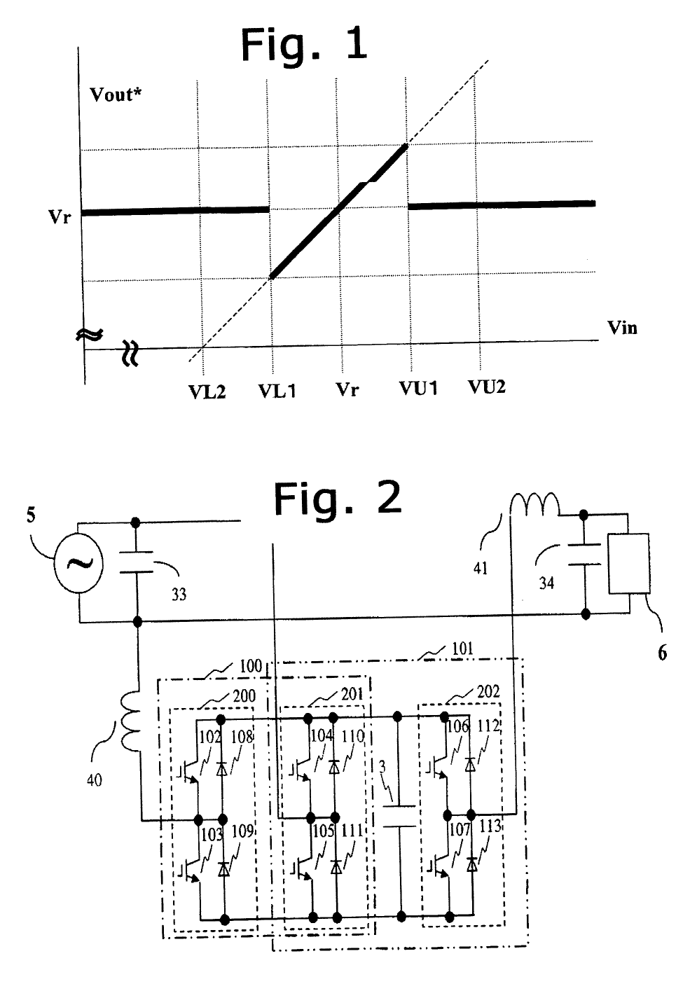

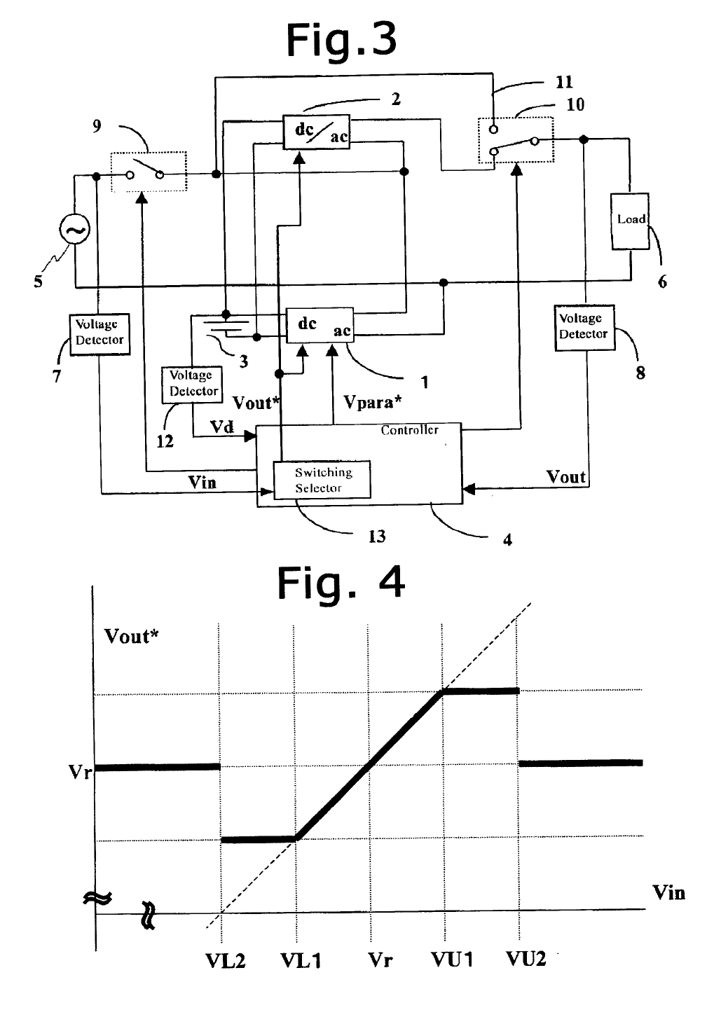

Embodiment 1 of the invention will be described with reference to FIG. 1. The uninterruptible power supply has the same structure as that of the example of a conventional uninterruptible power supply shown in FIG. 3, except that the output voltage pattern shown in FIG. 1 is used to control the output voltage instead of the output voltage pattern of FIG. 4.

When the input voltage value Vin is VL2≦Vin<VL1, then the output voltage target value Vout* is Vr and the series-side converter 2 outputs, by PWM control, the difference in input voltage (Vr−Vin) so that the output voltage is Vr. Based on the parallel-side output voltage instruction Vpara* from the control apparatus 4, the parallel-side converter 1 operates as a rectifier so that the DC voltage value Vd of the energy accumulation means 3 is a specified voltage.

When the input voltage value Vin is VU1<Vin≦VU2, then the output voltage target value Vout* is Vr and the series-side converter 2 controls, by PWM control, an excessive input voltage (Vr−Vin) so that the output voltage is Vr. Based on the parallel-side output voltage instruction Vpara* from the control apparatus 4, the parallel-side converter 1 operates as a rectifier so that the DC voltage value Vd of the energy accumulation means 3 is a specified voltage.

The other operations in the input voltage range are the same as those of the conventional example.

As described above, a single output voltage target value is used in the three input voltage ranges (VL2≦Vin<VL1, VU1<Vin≦VU2, Vin<VL2 or VU2<Vin) subjected to PWM control. As a result, the output voltage of the uninterruptible power supply can be maintained to have a predetermined value in the above three input voltage ranges, thus suppressing the effect of the input voltage on the output power, and suppressing the duty ratio of the semiconductor switch of the series-side converter.

### Embodiment 2

Embodiment 2 of the invention will be described with reference to FIG. 2. The same components as those of FIG. 3 are denoted with the same reference numerals and will not be described further.

FIG. 2 shows an uninterruptible power supply of the series-parallel circuit type, as in the conventional example, but in which the series-side converter is connected to the load rather than to the parallel-side converter. As shown in FIG. 2, the uninterruptible power supply consists of a parallel-side converter 100, a series-side converter 101, an energy accumulation means 3, an input filter capacitor 33, an output filter capacitor 34, an input filter reactor 40, and an output filter reactor 41. The parallel-side converter 100 includes a parallel leg 200 having semiconductor switches 102 and 103 and the diodes 108 and 109 connected thereto in an antiparallel manner. The converter 100 also includes a common leg 201, having semiconductor switches 104 and 105 and diodes 110 and 111 connected thereto in an antiparallel manner. The series-side converter 101 includes a series leg 202, having semiconductor switches 106 and 107 and diodes 112 and 113 connected thereto in an antiparallel manner, and the common leg 201. The common leg 201 is commonly used by the parallel-side converter 100 and the series-side converter 101, and the voltage on the line between the parallel leg 200 and the common leg 201 is the output voltage of the parallel-side converter 100, while the line voltage on the line between the series leg 202 and the common leg 201 is the output voltage of the series-side converter 101.

Next, an explanation of operations will be given.

When the input voltage value Vin is VL1≦Vin≦VU1, the semiconductor switches 104 and 106 are turned on when the input voltage is positive (Vin≧0), and the semiconductor switches 105 and 107 are turned on when the input voltage is negative (Vin<0). The input voltage is output via the semiconductor switches and diodes.

When the input voltage value Vin is Vin<VL2 or VU2<Vin, it is judged that the input voltage is abnormal, in which case a backup operation is performed. The backup operation entails, by utilizing the inverter function of parallel leg 200 and series leg 202, maintaining the output voltage at a predetermined voltage Vr.

The other operations in the input voltage range are the same as those of Embodiment 1.

As described above, when the input voltage value Vin is VL1≦Vin≦VU1, the semiconductor switch of the series-side converter 2 is switched at the same frequency as the input voltage, i.e., in accordance with the polarity of the input voltage. Thus, the switching loss can be reduced, in comparison to PWM control. The switching to the bypass circuit as in the conventional example is not performed, and thus there is no fluctuation in the output voltage due to the switching operation.

In the above-described embodiments, although the semiconductor switches 104 and 106 are turned on when the input voltage is positive (Vin≧0) and the semiconductor switches 105 and 107 are turned on when the input voltage is negative (Vin<0), the voltage also can be output, needless to say, by turning on the semiconductor switches 105 and 107 when the input voltage is positive and by turning on the semiconductor switches 104 and 106 when the input voltage is negative.

It is noted that the invention can be applied not only to a case where the input/output is a single-phase current, but also where the input is a three-phase current and the output is a single-phase current, or where both the input and output are a three-phase current.

1. An uninterruptible power supply, comprising:
a first converter connected in parallel with an AC power system;
a second converter series-connected to the AC power system;
an energy accumulation means provided between the first converter and the second converter so that power can be transferred therebetween; and
a control apparatus for controlling the first converter and the second converter, the control apparatus including an output voltage instruction switching means, with settings of:
a first voltage range that is equal to or higher than a first lower limit voltage value, that is equal to or lower than a first upper limit voltage value, and that includes a reference voltage value therebetween,
a second voltage range that is lower than the first lower limit voltage value and that is equal to or higher than a second lower limit voltage value,
a third voltage range that is higher than the first upper limit voltage value and that is equal to or lower than a second upper limit voltage value,
a fourth voltage range that is lower than the second lower limit voltage value, and
a fifth voltage range that is higher than the second upper limit voltage value,
wherein, when the AC power system has a system voltage that is within the first voltage range, the system voltage is output directly and, when the system voltage is within the second or third voltage range, the second converter is used to compensate the system voltage of the AC power system, and the reference voltage value is output, and
wherein, when the system voltage is within the fourth or fifth voltage range, the energy accumulation means and the second converter are used to generate output the reference voltage value.

2. The uninterruptible power supply of claim 1, wherein when the system voltage is within the first, second or third voltage range, the first converter acts as a rectifier for the storage of energy in the energy accumulation means.

3. An uninterruptible power supply, comprising:
a first converter connected in parallel with an AC power system;
a second converter series-connected to the first converter;
an energy accumulation means provided between the first converter and the second converter so that power can be transferred therebetween; and
a control apparatus for controlling the first converter and the second converter, the control apparatus including an output voltage instruction switching means, with settings of:
a first voltage range that is equal to or higher than a first lower limit voltage value, that is equal to or lower than a first upper limit voltage value, and that includes a reference voltage value therebetween,
a second voltage range that is lower than the first lower limit voltage value and that is equal to or higher than a second lower limit voltage value,
a third voltage range that is higher than the first upper limit voltage value and that is equal to or lower than a second upper limit voltage value,
a fourth voltage range that is lower than the second lower limit voltage value, and
a fifth voltage range that is higher than the second upper limit voltage value,
wherein, when the AC power system has a system voltage that is within the first voltage range, the second converter is caused to switch at a frequency of the AC power system and the system voltage is output via the second converter,
wherein, when the system voltage is within the second or third voltage range, the second converter is used to compensate the voltage of the AC power system and the reference voltage value is output, and
wherein, when the power supply system has a voltage that is within the fourth or fifth voltage range, the energy accumulation means and the second converter are used to generate and output the reference voltage value.

4. The uninterruptible power supply of claim 3, wherein when the system voltage is within the first, second or third voltage range, the first converter acts as a rectifier for the storage of energy in the energy accumulation means.
